(19) United States
(12) Patent Application Publication
(10) Pub. No.: US 2015/0258941 A1
(43) Pub. Date: Sep. 17, 2015

(54) Handheld Electronic Device Support and Electrical Connector

(71) Applicant: Edward Sanchez, Bakersfield, CA (US)

(72) Inventor: Edward Sanchez, Bakersfield, CA (US)

(21) Appl. No.: 14/645,083

(22) Filed: Mar. 11, 2015

Related U.S. Application Data
(60) Provisional application No. 61/950,879, filed on Mar. 11, 2014.

(51) Int. Cl. B60R 11/02; G06F 1/16

(52) U.S. Cl. CPC B60R 11/02; G06F 1/1632; B60R 2011/0007

(57) ABSTRACT

A handheld electronic device support and connector for a vehicle center console is provided. The support comprises a lid-closable cavity in which a serial bus connector is provided along the lower surface thereof, and the lid secures over the cavity when the connector is not in use. The cavity comprises an interior volume, a width configured to receive the width of a handheld electronic device, and a sufficient depth such that the base of the electronic device is support in an upstanding position. The lid comprises a spring-biased assembly with a pivot point, a spring member to bias the lid upwards, and a lid connector for securing the lid over the cavity when stowed. The serial bus connection electrically couples the electronic device to the vehicle infotainment system and powers the device. The cavity supports the electronic device such that the user can interrogate the display thereof while supported therein.

### CROSS REFERENCE TO RELATED APPLICATION

This application claims the benefit of U.S. Provisional Application No. 61/950,879 filed on Mar. 11, 2014. The above identified patent application is herein incorporated by reference in its entirety to provide continuity of disclosure.

### BACKGROUND OF THE INVENTION

### Field of the Invention

The present invention relates to handheld electronic devices and vehicle mounts therefor. More specifically, the present invention relates to a docking station for a handheld electronic device that enables user access, integration with the vehicle sound system, and a power supply for charging the handheld device.

Vehicles are being increasingly integrated with smartphones and other handheld electronic devices. Many vehicles provide an infotainment system that is capable of communicating with a handheld device for the purposes of transmitting data back and forth. The purposes of the integration include several entertainment and convenience uses. These range from facilitating hands-free use of a cellular phone, relaying text messages through the infotainment system, transmitting audio or video from the handheld device, and providing navigation instructions to the user or to the vehicle system. These uses are but a few examples in which a smartphone is integrated into a vehicle infotainment system. Systems of the future will continue to integrate handheld electronic devices to enhance the user experience and to provide the user with greater access to information and entertainment.

Most common methods of connecting and transmitting data include either through one of a wired or wireless connection. While wireless data transfer provides a method of connecting a handheld device to a vehicle infotainment system without a physical connection, this type of connection does not provide power to the handheld device. Wired connections generally provide a power and data connection that electrically couples the handheld device to the infotainment system, whereby the device can be powered and simultaneously transfer data over a serial bus connection.

The present invention provides an assembly that offers a wired connection between a handheld device and a vehicle infotainment system, while simultaneously providing a physical support therefor that affords access to the device. Specifically, the present invention provides a vehicle center console support for a handheld electronic device that supports the device in an upstanding position while electrically coupling the device to the vehicle infotainment system.

### SUMMARY OF THE INVENTION

The following summary is intended solely for the benefit of the reader and is not intended to be limiting in any way. The present invention provides a new connector and support for a handheld electronic device wherein the same can be utilized for supporting a handheld electronic device along a vehicle console and for connecting the device to the vehicle infotainment system.

It is therefore an object of the present invention to provide a new and improved handheld electronic device connection that has all of the advantages of the prior art and none of the disadvantages.

It is another object of the present invention to provide a handheld electronic device connection that supports a handheld electronic device along the center console of a vehicle interior and supports the electronic device in an upstanding position therealong.

Another object of the present invention is to provide a handheld electronic device connection that provides a serial bus connector for the electronic device, whereby the device can be charged and electrically connected to vehicle infotainment system for transferring data therebetween.

Yet another object of the present invention is to provide a handheld electronic device connection that includes a hinged lid over a cavity, whereby the cavity is exposable and used to support the handheld electronic device in an upstanding position.

Another object of the present invention is to provide a handheld electronic device connection that may be integrated into existing vehicles, or alternatively integrated into vehicles by original equipment manufacturers before delivery.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the present invention in a stowed state along the center console of a vehicle.

FIG. 2 shows a close-up view of the assembly in a deployed state.

FIG. 3 shows a pair of the assemblies in a deployed state along the center console of a vehicle.

### DETAILED DESCRIPTION OF THE INVENTION

Reference is made herein to the attached drawings. Like reference numerals are used throughout the drawings to depict like or similar elements of the handheld electronic device support and infotainment connection. For the purposes of presenting a brief and clear description of the present invention, the preferred embodiment will be discussed as used for supporting a smartphone device in a substantially upright condition and for connecting the smartphone to the vehicle's infotainment system. The figures are intended for representative purposes only and should not be considered to be limiting in any respect.

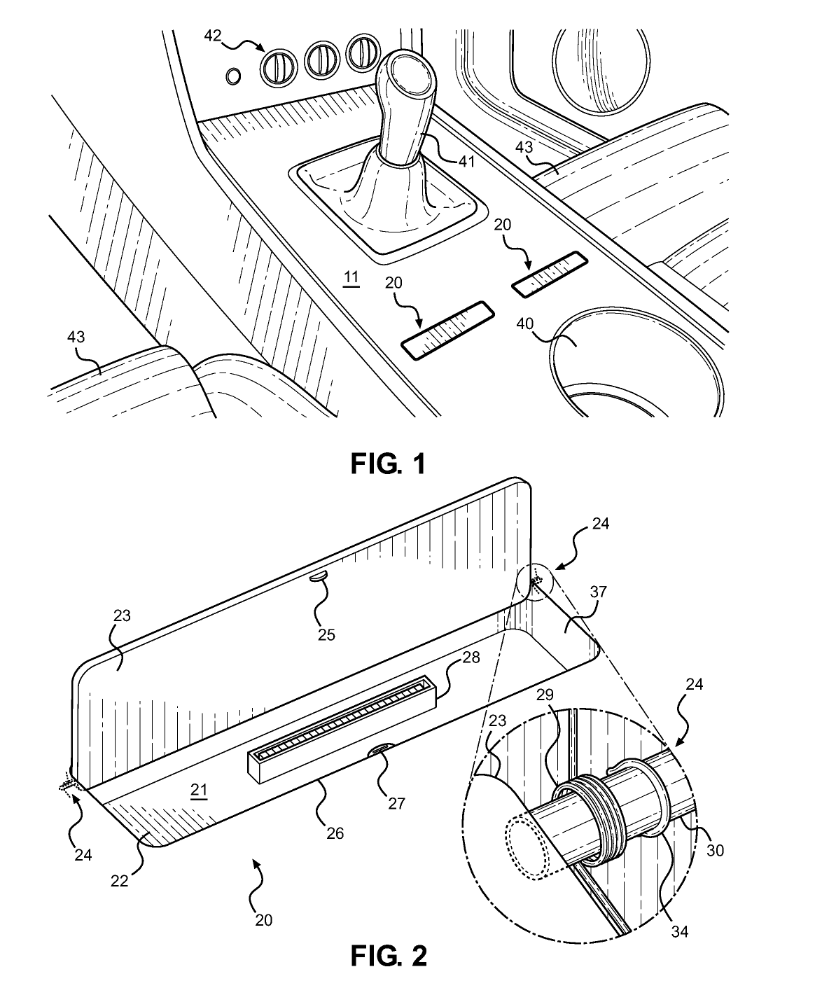

Referring now to FIG. 1, there is shown a view of the handheld electronic device support of the present invention disposed within a vehicle interior. The handheld electronic device support comprises an assembly that is configured to support a handheld electronic device, such as a smartphone or media player, in a substantially upright condition within the interior of a vehicle. The handheld electronic device is therefore supported and visible to the driver or passengers, and the user can interrogate and interact with the display thereof.

Most modern cars include a vehicle infotainment system, which comprises a stereo system and display screen that offers connectivity for personal handheld electronic devices. Common connections include local wireless connections, such as Bluetooth RF connections and the like. Usually provided along with a wireless connection is a wired auxiliary connector, which physically couples the handheld electronic device to the infotainment system. In either embodiment, the connectively provided allows data transfer between the handheld electronic device and the infotainment system for displaying information, for playing audio and visual data, for facilitating hands-free voice calls, for navigation, and for using various applications and features on the handheld device through the infotainment system. The present invention contemplates a physical support built into the center console of a vehicle that supports a handheld electronic device, and optionally provides a connector for physically connecting the handheld electronic device to the vehicle infotainment system.

Referring again to FIG. 1, a first and second handheld electronic device support 20 is provided along the center console between two vehicle seats 43. The handheld electronic device support comprises a cavity that is normally covered by a hinged lid, whereby the cavity supports the lower end of a handheld electronic device such that the device rests in a substantially upright condition while positioned therein. The hinged lid is opened to reveal the cavity, whereafter the user can place his or her handheld electronic device into the cavity and interrogate the display thereof while being supported.

The one or more handheld electronic device supports 20 are positioned on the center console 11 of the vehicle, and preferably adjacent to existing cup holders 40, gear shift levers 41, and climate control knobs 42. The center console 11 comprises an upper surface, through which the handheld electronic device supports 20 are disposed. The upper surface of the lid thereover is flush with the upper surface of the center console 11 such that the supports are not conspicuously visible while not in use. When in use, the hinged lid is opened and the user places his or her handheld electronic device into the open cavity thereof.

Referring now to FIG. 2, there is shown a close-up view of the handheld electronic device support of the present invention, whereby the hinged lid 23 is in an open state and the cavity 22 thereunder is visible. The cavity 22 of the present invention comprises a lower surface 21 and upstanding sidewalls 37 defining an open interior volume. The cavity furthermore comprises a length 26, width, and a depth, whereby the dimensions of the length and width are sized to receive the lower end of a handheld electronic device therein. The sidewall 37 comprises a sufficient depth such that the lower end of the handheld electronic device is supported by the sidewalls 37 and the handheld electronic device remains in a substantially upright condition while its lower end is positioned therein.

Disposed over the upper surface of the cavity is the hinged lid 23. The hinged lid 23 preferably comprises a first and second hinge pin assembly 24 along a first edge thereof. The first edge forms the pivot point of the lid 23, whereby hinge pins 30 extend from the ends of the lid. The hinge pins 30 are concentric and are aligned along the first edge of the lid 23 to allow pivoting of the lid from that edge. Along an opposing edge of the lid is a latch member 25. The latch member 25 engages a latch 27 disposed along the sidewall of the cavity and is used to removably secure the latch member 25 therein when the lid 23 is in a closed state. The latch 27 and the latch member 25 are preferably disengaged by the user pressing down on the lid, which allows the latch 27 to release the latch member 25 such that the lid 23 pivots upwards.

A close-up view of the hinge pin assembly 24 is provided in FIG. 2. The hinge pin assembly 24 comprises the elongated hinge pin 30, a torsion spring 29, and a hinge pin receiving assembly 34. The torsion spring 29 is coiled around the hinge pin 30 at each end of the lid and biases the lid into an upright, open state. The hinge pin receiving assembly 24 comprises an assembly configured to support the hinge pin and allow the hinge pin to rotate therein. This assembly is preferably an aperture through the sidewall 37 of the cavity, or alternatively may also a clevis member having an aperture and supporting the exterior of the hinge pin along the sidewall.

Along the lower surface 21 of the cavity 22 is a serial bus connector 28 that is adapted to electrically couple a handheld electronic device to the infotainment system of the vehicle. The serial bus connector 28 is electrically connected to the vehicle infotainment system and to the vehicle electrically system such that a handheld electronic device coupled thereto can transmit and receive data from the infotainment system while receiving electrical power to charge the battery of the handheld device. This allows a user to send signals to the infotainment system for displaying and transmitting textual, audio, and visual data on the screen of the infotainment system and from the speakers of the vehicle speaker system. The serial bus connector 28 therefore provides an auxiliary input for the infotainment system that is nested within the cavity 22.

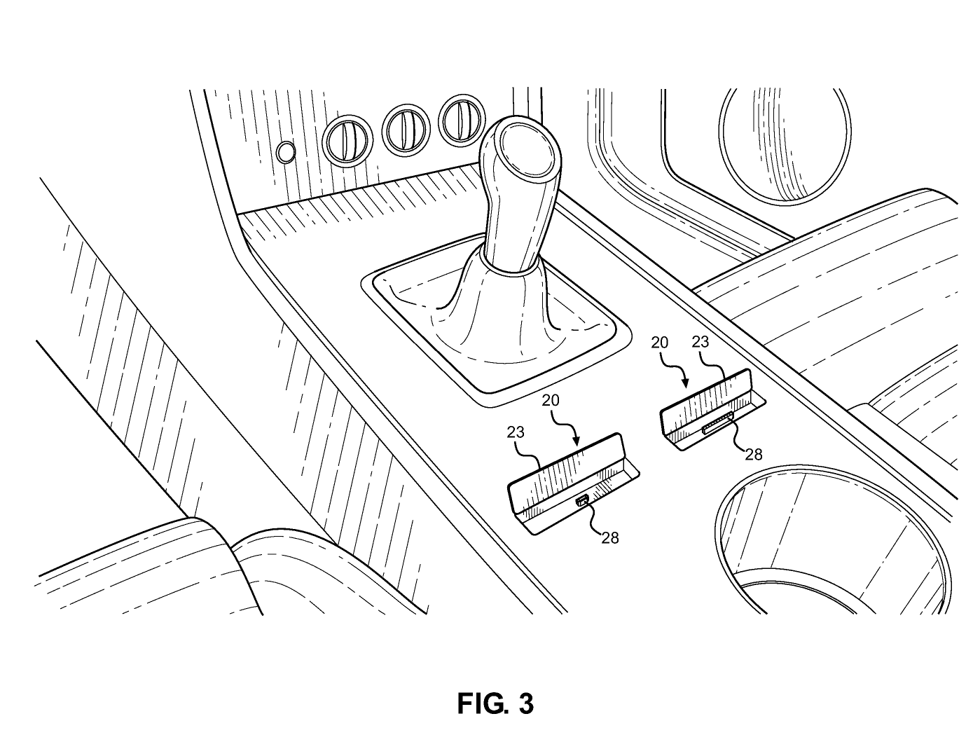

Referring now to FIG. 3, there is shown a view of a pair of handheld electronic device supports 20 in an open state, whereby two serial bus connectors 28 are provided. The lids 23 of the handheld electronic device supports 20 are open and the cavities of each support are exposed. The cavity of each support preferably comprises a length and a width that is adapted to receive therein the lower end of a smartphone device, whereby the smartphone is supported by the sidewalls of the cavity when placed therein and the smartphone maintains a substantially upright state. Average smartphone devices have a lower end that is generally less than six inches across and less than one inch in thickness. Therefore, to accommodate most smartphones, the cavity length is preferably between three to six inches across, and the width of the cavity is preferably one inch or less. These dimensions are provided as a way of informing one skilled in the art as to the meaning of what cavities are contemplated as falling within the claimed invention. The cavity length and the width are preferably sized to receive the lower end of the smartphone, whereby the above dimensions represent common smartphone dimensions. These numbers are not considered to be limiting, but are considered typical dimensions that would allow one skilled in the art to design the cavities for the purposes of supporting the same and receiving the lower end within the cavity interior.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A handheld electronic device support system for supporting a handheld electronic device along the center console of a vehicle, comprising:
a center console surface disposed between a first and second vehicle seat;
at least one handheld electronic device support comprising a cavity having a length, a width, a lower surface, and a depth forming an interior volume;
the length of the cavity relative to the width being configured to receive a lower end of a smartphone therethrough, and the depth of the cavity being sufficient to support the lower end smartphone in a substantially upstanding position;
a hinged lid disposed over an upper surface of the cavity, whereby the hinged lid has an upper surface that is substantially planar when in a closed state over the upper surface of the cavity;
the hinged lid comprises a spring biased hinge along a first edge of the hinged lid, and a latch along an opposing edge thereof, whereby the spring biased hinge biases the hinged lid into an upright condition and the latch secures the hinged lid in the closed state over the upper surface of the cavity.

2. The handheld electronic device support system of claim 1, further comprising:
a serial bus connector along the lower surface of the cavity that is configured to electrically couple to the smartphone when the lower end of the smartphone is placed within the cavity;
the serial bus connector being electrically connected to an infotainment system within the vehicle and furthermore electrically connected to a power source;
the serial bus connector being adapted to transfer data to and from the smartphone to the infotainment system, and furthermore being adapted to supply electrical power to the smartphone for charging purposes.

3. The handheld electronic device support system of claim 1, wherein:
the cavity further comprises upstanding sidewalls;
the spring biased hinge further comprises a first and second hinge pin extending from first edge of the hinged lid;
the first and second hinge pin being supported by a clevis coupled to the sidewalls of the cavity;
a torsion spring supported along the first and second hinge pin for biasing the hinged lid into the upright condition.

4. A handheld electronic device support system for supporting a handheld electronic device along the center console of a vehicle, comprising:
a center console surface disposed between a first and second vehicle seat;
at least one handheld electronic device support comprising a cavity having a length, a width, a lower surface, and a depth forming an interior volume;
a hinged lid disposed over an upper surface of the cavity, whereby the hinged lid has an upper surface that is substantially planar when in a closed state over the upper surface of the cavity;
the hinged lid comprises a spring biased hinge along a first edge of the hinged lid, and a latch along an opposing edge thereof, whereby the spring biased hinge biases the hinged lid into an upright condition and the latch secures the hinged lid in the closed state over the upper surface of the cavity;
a serial bus connector along the lower surface of the cavity that is configured to electrically couple to a handheld electronic device when the lower end of the handheld electronic device is placed within the cavity;
the serial bus connector being electrically connected to an infotainment system within the vehicle and furthermore electrically connected to a power source;
the serial bus connector being adapted to transfer data to and from the handheld electronic device to the infotainment system, and furthermore being adapted to supply electrical power to the handheld electronic device for charging purposes.

5. The handheld electronic device support system of claim 4, wherein:
wherein the handheld electronic device comprises a smartphone;
the length of the cavity relative to the width being configured to receive a lower end of the smartphone therethrough, and the depth of the cavity being sufficient to support the lower end smartphone in a substantially upstanding position;

6. The handheld electronic device support system of claim 4, wherein:
the cavity further comprises upstanding sidewalls;
the spring biased hinge further comprises a first and second hinge pin extending from first edge of the hinged lid;
the first and second hinge pin being supported by a clevis coupled to the sidewalls of the cavity;
a torsion spring supported along the first and second hinge pin for biasing the hinged lid into the upright condition.
